(19) United States
(12) Patent Application Publication
(10) Pub. No.: US 2018/0258631 A1
(43) Pub. Date: Sep. 13, 2018

(54) Screen Enclosure Frame Bracket

(71) Applicants: DAVID ROYCE PEARSON, Derby (GB); EDWARD WILLIAM PITHER, NAPLES, FL (US)

(72) Inventors: DAVID ROYCE PEARSON, Derby (GB); EDWARD WILLIAM PITHER, NAPLES, FL (US)

(21) Appl. No.: 15/455,202

(22) Filed: Mar. 10, 2017

(51) Int. Cl. E04B 1/18; E04B 2/72; F16M 13/02

(52) U.S. Cl. CPC E04B 1/185; F16M 13/02; E04B 2/721

(57) ABSTRACT

A bracket for a screen enclosure frame system includes a planar lateral brace portion having, connected thereto, a pair of opposing, lateral planar flanges extending upwardly along parallel planes perpendicular to the lateral brace portion; a planar central portion connected to the lateral brace portion, the central portion having, connected thereto, a planar front flange extending upwardly and perpendicular to the central portion and a planar wing portion extending perpendicular to the lateral brace portion. The lateral brace portion, the central portion, and the wing portion are coplanar. The bracket can optionally include another wing portion, a drainage structure, and/or a mounting structure.

### FIELD OF THE INVENTION

The present invention relates to screen enclosure frame systems, and more specifically, to screen enclosure frame brackets.

### BACKGROUND OF THE INVENTION

Screen enclosure frames are used to define screened areas, such as lanais, and are generally mounted to floors, ceilings, and/or other structures. Once mounted, screen material can be mounted to such frames to define the screened areas. Such frames generally include vertical and horizontal members along with brackets to mount the members to each other and/or other structures. In a typical arrangement, horizontal members can span along peripheral edges of a concrete surface with vertical members extending upwardly between the horizontal members at desired intervals. In certain applications, vertical members can be mounted to a structure, such as an external wall. In other applications, angle or “L” brackets are commonly used to mount vertical members to a surface by engaging an external surface of a vertical member and the surface, and to mount the horizontal members to the vertical members by engaging an external surface of a horizontal member and an external surface of a vertical member.

### SUMMARY OF THE INVENTION

It is an object of the present invention to provide a screen enclosure frame bracket that can utilized with a screen enclosure frame system.

It is another object of the present invention to provide a screen enclosure frame bracket that overcomes at least one deficiency in the prior art.

In an exemplary environment, a screen enclosure frame system can include a vertical member having front, rear, left, and right sides, with the sides having respective inner surfaces; and a hollowed horizontal member having top, right, and left sides, and an open bottom.

In an exemplary embodiment of the present invention, a screen enclosure frame bracket can include a planar lateral brace portion having, connected thereto, a pair of opposing, lateral planar flanges extending upwardly along parallel planes perpendicular to the lateral brace portion; and a planar central portion connected to the lateral brace portion, with the central portion having connected thereto, a planar front flange extending upwardly and perpendicular to the central portion, and a planar wing portion extending perpendicular to the lateral brace portion.

In exemplary aspects of the present invention, the lateral brace portion, the central portion, and the wing portion can be coplanar; and with the bracket fixed to a level surface, the horizontal member can be configured to cover the planar wing portion, and the vertical member can be configured to fit around the front and lateral flanges with the inner surfaces respectively abutting the front and lateral flanges.

In optional exemplary aspects, such a screen enclosure frame bracket can further include any combination of the following:
the bracket can include at least one drainage element;
the bracket can include at least one mounting element;
the bracket can further comprise a planar extension portion connected to the lateral brace portion opposite the central portion, with the extension portion, lateral brace portion, central portion, and wing portion being coplanar;
one of an extension portion and a lateral brace portion can have, connected thereto, a planar rear flange extending upwardly, perpendicular to the one of an extension portion or a lateral brace portion, and in parallel with the front flange, with the rear side including a respective inner surface, and the vertical member being configured to fit around the front, rear, and lateral flanges with the inner surfaces respectively abutting the front, rear, and lateral flanges; and
the central portion can have, connected thereto, another planar wing portion extending perpendicular to the lateral brace portion and opposite the wing portion, with the lateral brace portion, central portion, wing portion, and other wing portion being coplanar.

These and other exemplary aspects and embodiments of the present invention are further described herein.

### BRIEF DESCRIPTION OF THE DRAWINGS

FIG. 1a illustrates an exemplary embodiment of a screen enclosure frame bracket in pre-manipulated form, with the bracket having a lateral brace portion with a pair of lateral planar flanges; a central portion with a front flange and a wing portion; and optional drainage and mounting elements.

FIG. 1b illustrates the exemplary embodiment of FIG. 1a in a finished form, with the pair of lateral planar flanges and the front flange extending upwardly.

FIG. 2a illustrates an exemplary embodiment of a screen enclosure frame bracket in pre-manipulated form, with the bracket having a lateral brace portion with a pair of lateral planar flanges, a central portion with a front flange and a wing portion, an extension portion, and optional drainage and mounting elements.

FIG. 2b illustrates the exemplary embodiment of FIG. 2a in a finished form, with the pair of lateral planar flanges and the front flange extending upwardly.

FIG. 3a illustrates an exemplary embodiment of a screen enclosure frame bracket in pre-manipulated form, with the bracket having a lateral brace portion with a pair of lateral planar flanges; a central portion with a front flange, a wing portion, and another wing portion; and optional drainage and mounting elements.

FIG. 3b illustrates the exemplary embodiment of FIG. 3a in a finished form, with the pair of lateral planar flanges and the front flange extending upwardly.

FIG. 4a illustrates an exemplary embodiment of a screen enclosure frame bracket in pre-manipulated form, with the bracket having a lateral brace portion with a pair of lateral planar flanges; a central portion with a front flange, a wing portion, and another wing portion; an extension portion having a rear flange; and optional drainage and mounting elements.

FIG. 4b illustrates the exemplary embodiment of FIG. 4a in a finished form, with the pair of lateral planar flanges and the front and rear flanges extending upwardly.

FIG. 5a illustrates an exemplary embodiment of a screen enclosure frame bracket in pre-manipulated form, with the bracket having a lateral brace portion with a rear flange and a pair of lateral planar flanges; a central portion with a front flange, a wing portion, and another wing portion; and optional drainage and mounting elements.

FIG. 5b illustrates the exemplary embodiment of FIG. 5a in a finished form, with the pair of lateral planar flanges and the front and rear flanges extending upwardly.

FIG. 6a illustrates an exemplary screen enclosure frame bracket having a wing portion as part of a screen enclosure frame system that includes a horizontal member and a vertical member.

FIG. 6b illustrates another exemplary screen enclosure frame bracket having a wing portion and another wing portion as part of a screen enclosure frame system that includes a horizontal member and a vertical member.

FIG. 6c illustrates still another exemplary screen enclosure frame bracket having a wing portion, another wing portion, and a rear flange as part of a screen enclosure frame system that includes a horizontal member and a vertical member.

### DETAILED DESCRIPTION

It should be noted that this disclosure includes a plurality of embodiments, each having a plurality of elements and aspects, and such elements and aspects need not necessarily be interpreted as being conjunctively required by one or more embodiments of the present invention. Rather, all combinations of the one or more elements and/or aspects can enable a separate embodiment of the present invention, which may be claimed with particularity in this or any future filed Non-Provisional Patent Applications. Moreover, any particular materials, structures, and/or sizes disclosed herein, whether expressly or implicitly, are to be construed strictly as illustrative and enabling, and not necessarily limiting. Therefore, it is expressly set forth that such materials, structures, and/or sizes independently or in any combination thereof, are merely illustratively representative of one or more embodiments of the present invention and are not to be construed as necessary in a strict sense.

Further, to the extent the same element or aspect is defined differently within this disclosure, whether expressly or implicitly, the broader definition is to take absolute precedence, with the distinctions encompassed by the narrower definition to be strictly construed as optional.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention.

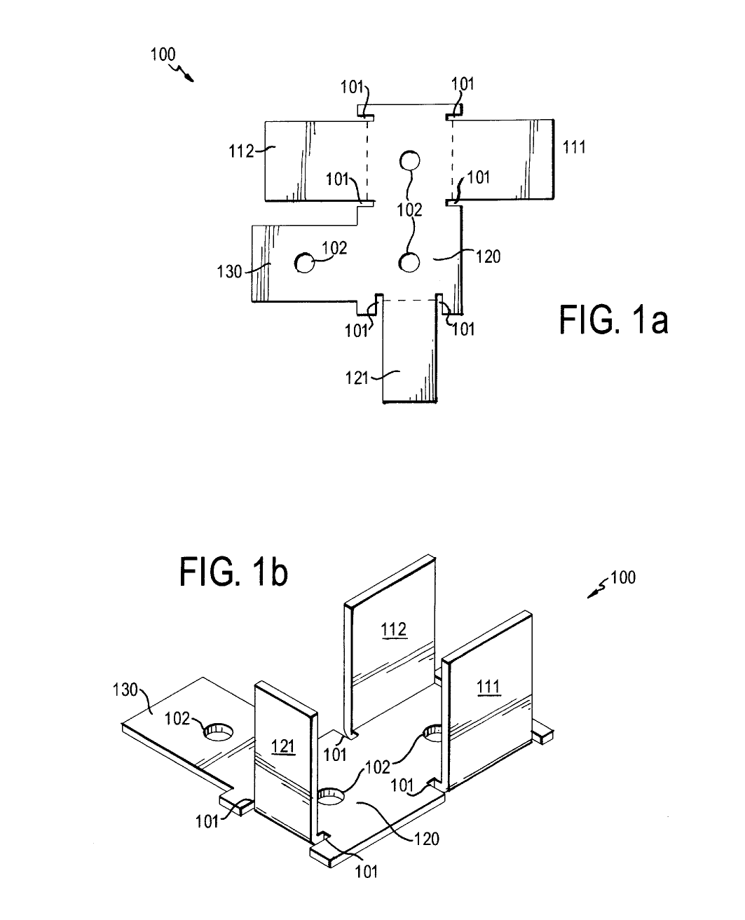

According to the present invention, a screen enclosure frame bracket can be formed from any one or more materials, such as one or more of plastic, rubber, wood, metal, such as aluminum for example and not in limitation, a crystalline material, or any other man-made or naturally occurring material, for example and not in limitation, insofar as the same is functionally consistent with the invention as described, in which such a material or combination of materials provide sufficient rigidity to provide structural support for a screen enclosure frame system. Further, such a bracket can be manufactured in any one or more functionally compatible manners, such as via molding, stamping, heating, bending, machining, etc. to provide a bracket in an initial and/or a configured state. For example and not in limitation, FIGS. 1a-5b illustratively show exemplary brackets 100 in initial states (FIGS. 1a, 2a, 3a, 4a, and 5a) and configured states (FIGS. 1b, 2b, 3b, 4b, and 5b), with the configured state having respective portions of the bracket bent upwardly to form respective flanges, as further described herein.

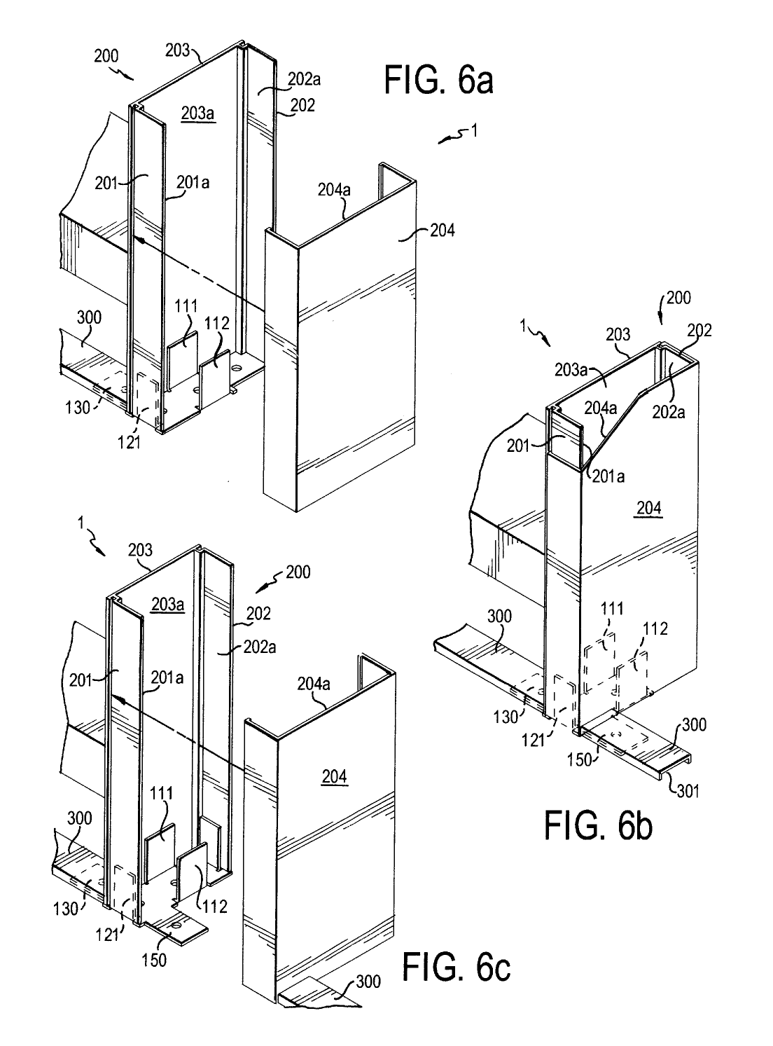

FIGS. 6a-6c illustrate an exemplary environment of the present invention, in which exemplary screen enclosure frame brackets 100 can be utilized in conjunction with a vertical member 200 and a horizontal member 300. Notably, vertical member 200 is illustratively shown as a two-piece unit, which can provide construction efficiencies, yet can be provided in any structurally compatible size, shape, or number desired. Further, vertical member 200 can be provided with a parallelepiped shape having front, rear, left, and right sides 201, 202, 203, 204, with the sides having respective inner surfaces 201a, 202a, 203a, 204a. Further notably, horizontal member 300 is illustratively shown with a hollowed construction and having an open bottom 301, such that a horizontal member can be positioned over, and cover, portions of bracket 100 when engaged against a level surface, which can provide a cleaner, finished appearance. Lastly, it should be noted that vertical and horizontal members 200, 300 can be provided with any alternative shapes to the extent desired and functionally compatible with the present invention, and the same are intended to be included in the range of equivalents of the present invention.

FIGS. 1a and 1b illustrate an exemplary embodiment of the present invention, in which a screen enclosure frame bracket 100 can include a planar lateral brace portion 110 having, connected thereto, a pair of opposing, lateral planar flanges 111,112 extending upwardly along parallel planes perpendicular to the lateral brace portion; and a planar central portion 120 connected to said lateral brace portion, with the central portion having, connected thereto, a planar front flange 121 extending upwardly and perpendicular to the central portion and a planar wing portion 130 extending perpendicular to said lateral brace portion. In an exemplary aspect, lateral brace portion 110, central portion 120, and wing portion 130 can be coplanar.

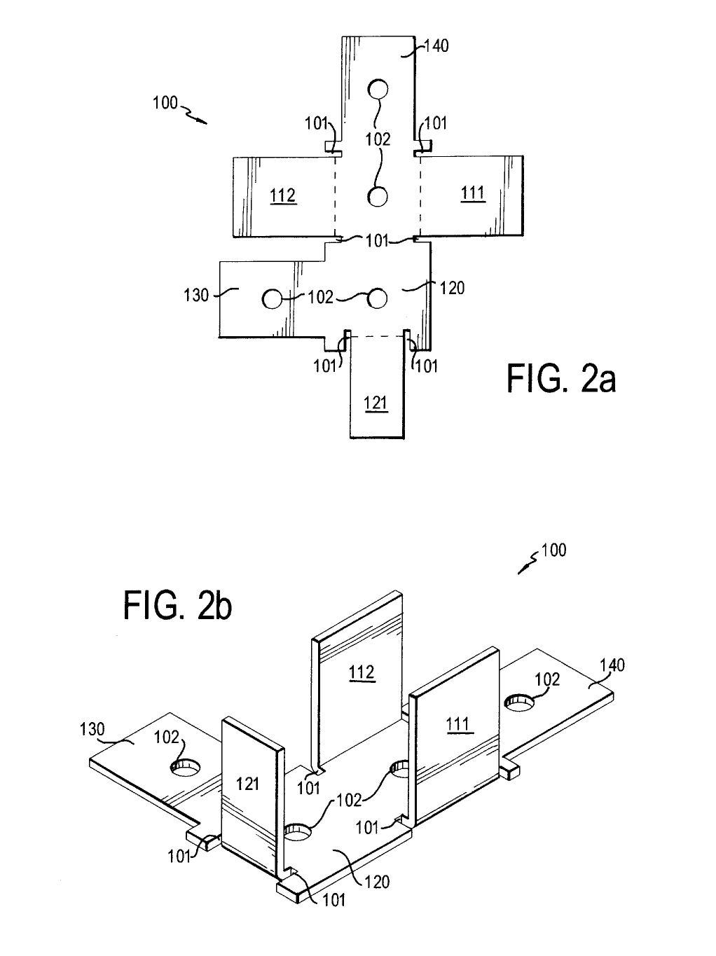

FIGS. 2a and 2b illustrate another exemplary embodiment of the present invention, in which a screen enclosure frame bracket 100 can optionally include a planar extension portion 140 connected to lateral brace portion 110 opposite central portion 120. In an exemplary aspect, extension portion 140, lateral brace portion 110, central portion 120, and wing portion 130 can be coplanar.

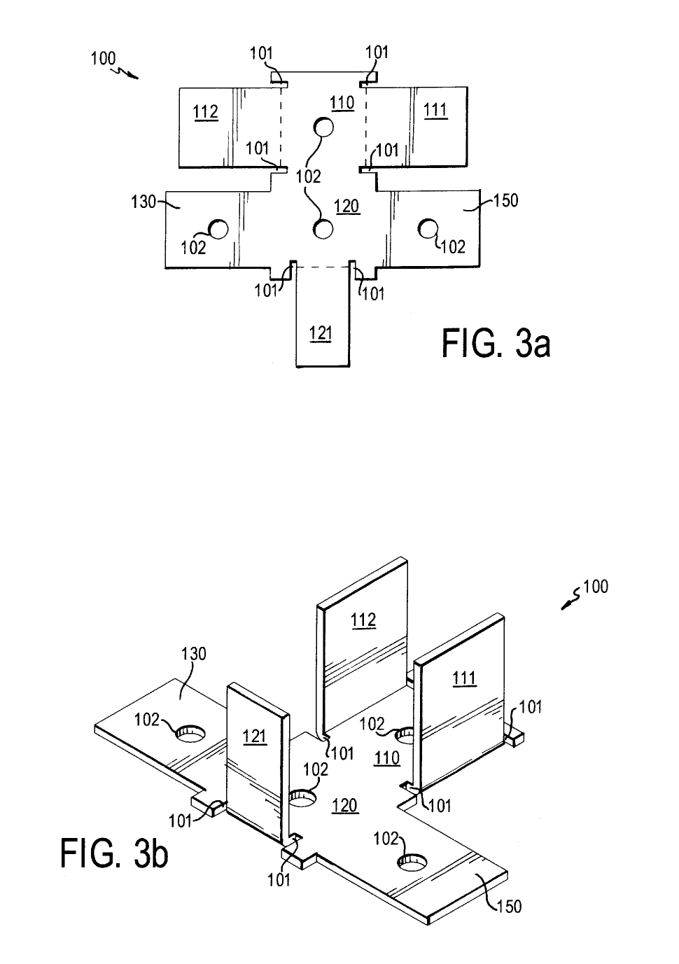

FIGS. 3a and 3b illustrate yet another exemplary embodiment of the present invention, in which a screen enclosure frame bracket 100 can be optionally configured with central portion 120 having, connected thereto, another planar wing portion 150 extending perpendicular to lateral brace portion 110 and opposite wing portion 130. In another exemplary aspect, lateral brace portion 110, central portion 120, wing portion 130, and other wing portion 150 can be coplanar.

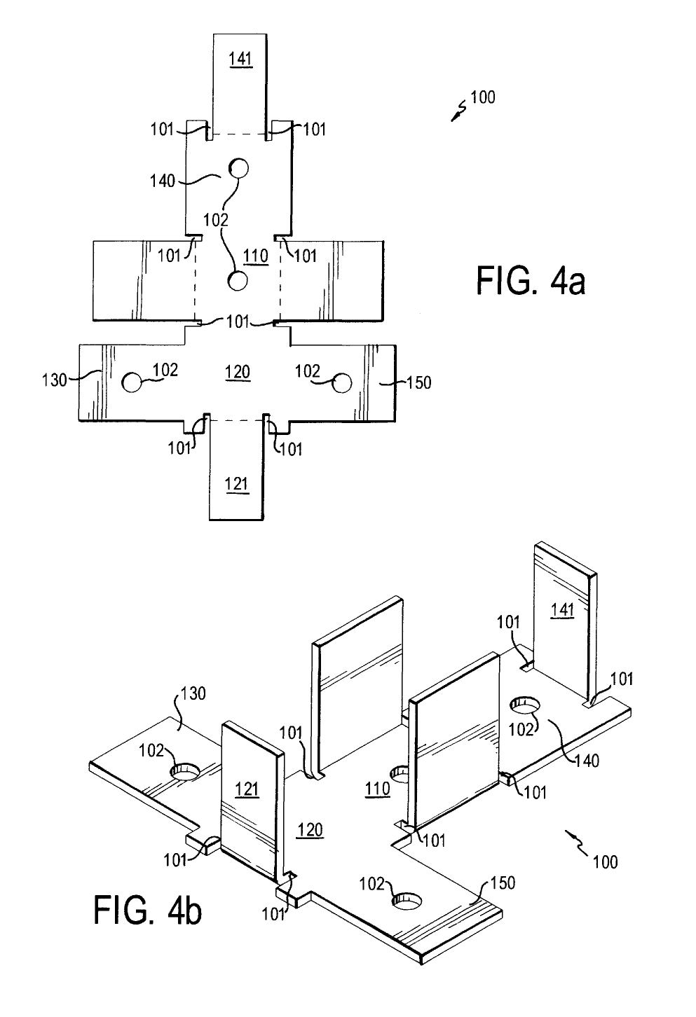

FIGS. 4a and 4b illustrate still another exemplary embodiment of the present invention, in which a screen enclosure frame bracket 100 can be optionally configured with extension portion 140 having, connected thereto, a planar rear flange 141 extending upwardly, perpendicular to the extension portion, and in parallel with front flange 121.

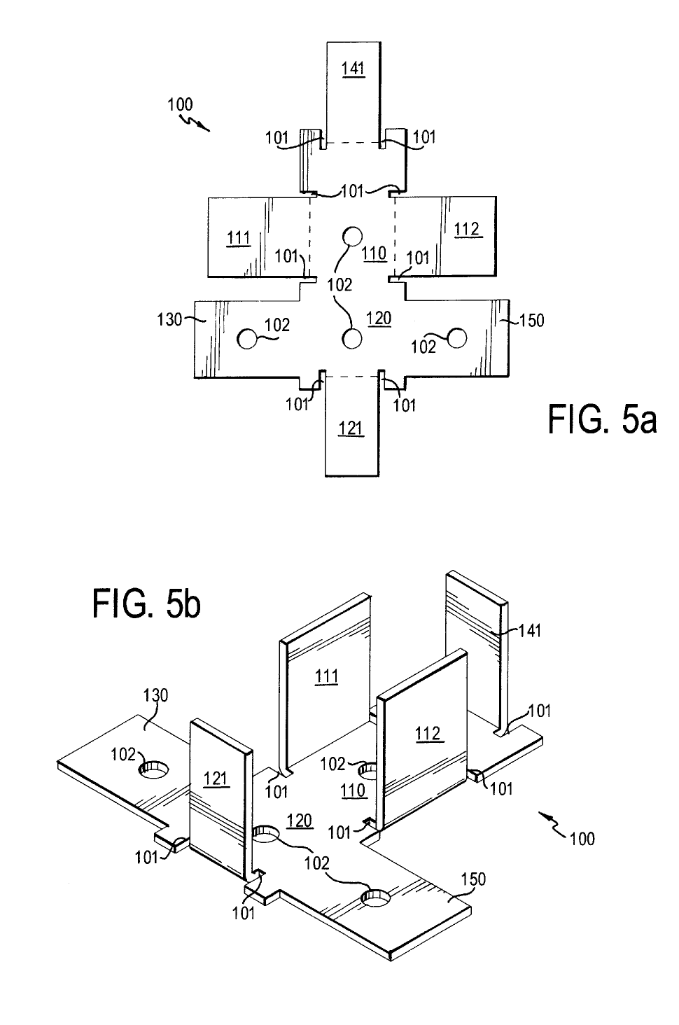

FIGS. 5a and 5b illustrate still yet another exemplary embodiment of the present invention, in which a screen enclosure frame bracket 100 can be optionally configured with lateral brace portion 110 having, connected thereto, planar rear flange 141 extending upwardly, perpendicular to the lateral brace portion, and in parallel with front flange 121.

As illustratively shown in FIGS. 1a-6b, optionally, frame bracket 100 can optionally be provided with one or more drainage elements 101. As illustratively shown, drainage element 101 can be provided as a slot extending to a terminal edge of lateral brace portion 110, central portion 120, wing portion 130, or other wing portion, and can provide an opening to facilitate water drainage and/or air circulation. Notably, drainage element 101 can be provided with any functionally compatible shape and location desired, and in not limited to a slot as illustratively shown.

As further illustrated in FIGS. 1a-6b, also optionally, frame bracket 100 can be provided with one or more mounting elements 102. As illustratively shown, mounting element 102 can be provided as an aperture extending through lateral brace portion 110, central portion 120, wing portion 130, other wing portion, and/or any other portion of bracket 100, and can provide an opening through which a screw (not shown) or any other desired structure can engage a surface to which the bracket 100 is attached. Notably, mounting element 102 can be provided with any functionally compatible shape and/or location desired, and is not necessarily limited to an aperture as illustratively shown.

FIGS. 6a-6c illustrate exemplary configurations of bracket 100 with vertical member 200 and horizontal member 300. As noted above, frame bracket 100 can be fixed to a level surface, such as a floor, wall, or other surface via any desired attachment structure desired, such as a screw, nail, bolt, adhesive, etc., that is functionally compatible with the present invention. With a frame bracket 100 fixed to a level surface, horizontal member 300 can be disposed over wing portion 130 and/or other wing portion 150, whilst vertical member 200 can be positioned around front and lateral flanges 121, 111, 112, (and optional rear flange 141, if provided), such that inner surfaces 201a, 202a, 203a, 204a respectively abut front, optional rear, and lateral flanges. As such, one or more screws (not shown) or any combination of any other desired attachment structures (as noted above) can be utilized to attach vertical member 200 to such flanges, such as a screw passing through the vertical member and a flange.

It will be apparent to one of ordinary skill in the art that the manner of making and using the claimed invention has been adequately disclosed in the above-written description of the exemplary embodiments and aspects.

It should be understood, however, that the invention is not necessarily limited to the specific embodiments, aspects, arrangement, and components shown and described above, but may be susceptible to numerous variations within the scope of the invention. For example, while the present invention is illustratively shown with particular shapes and relative sizes, any functionally compatible shape(s) and size(s) can be provided to the extent desired.

Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents of the appended claims.

Therefore, I claim:

1. A rigid bracket for a screen enclosure frame system including a parallelepiped vertical member having front, rear, left, and right sides, with the front, right, and left sides having respective inner surfaces, and a hollow horizontal member having an open bottom, said bracket comprising:
a planar lateral brace portion having, connected thereto, a pair of opposing, lateral planar flanges extending upwardly along parallel planes perpendicular to the lateral brace portion;
a planar central portion connected to said lateral brace portion, said central portion having, connected thereto, a planar front flange extending upwardly and perpendicular to the central portion and a planar wing portion extending perpendicular to said lateral brace portion;
wherein said lateral brace portion, said central portion, and the wing portion are coplanar, and with said bracket fixed to a level surface, the horizontal member is configured to cover the planar wing portion, and the vertical member is configured to fit around the front and lateral flanges with the inner surfaces respectively abutting the front and lateral flanges.

2. The bracket of claim 1, wherein said bracket includes at least one drainage element.

3. The bracket of claim 2, wherein said bracket includes at least one mounting element.

4. The bracket of claim 1, wherein said bracket includes at least one mounting element.

5. The bracket of claim 1, wherein said bracket further comprises a planar extension portion connected to said lateral brace portion opposite the central portion, with said extension portion, said lateral brace portion, said central portion, and the wing portion being coplanar.

6. The bracket of claim 5, wherein said bracket includes at least one drainage element.

7. The bracket of claim 6, wherein said bracket includes at least one mounting element.

8. The bracket of claim 5, wherein said bracket includes at least one mounting element.

9. The bracket of claim 5, wherein said extension portion has, connected thereto, a planar rear flange extending upwardly, perpendicular to said extension portion, and in parallel with the front flange, the rear side includes a respective inner surface, and the vertical member is configured to fit around the front, rear, and lateral flanges with the inner surfaces respectively abutting the front, rear, and lateral flanges.

10. The bracket of claim 9, wherein said bracket includes at least one drainage element.

11. The bracket of claim 10, wherein said bracket includes at least one mounting element.

12. The bracket of claim 9, wherein said bracket includes at least one mounting element.

13. The bracket of claim 1, wherein said lateral brace portion has, connected thereto, a planar rear flange extending upwardly, perpendicular to said lateral brace portion, and in parallel with the front flange, the rear side includes a respective inner surface, and the vertical member is configured to fit around the front, rear, and lateral flanges with the inner surfaces respectively abutting the front, rear, and lateral flanges.

14. The bracket of claim 13, wherein said bracket includes at least one drainage element.

15. The bracket of claim 14, wherein said bracket includes at least one mounting element.

16. The bracket of claim 13, wherein said bracket includes at least one mounting element.

17. The bracket of claim 1, wherein said central portion has, connected thereto, another planar wing portion extending perpendicular to said lateral brace portion and opposite the wing portion, with said lateral brace portion, said central portion, the wing portion, and the other wing portion being coplanar.

18. The bracket of claim 17, wherein said bracket includes at least one drainage element.

19. The bracket of claim 18, wherein said bracket includes at least one mounting element.

20. The bracket of claim 17, wherein said bracket includes at least one mounting element.

21. The bracket of claim 17, wherein said bracket further comprises a planar extension portion connected to said lateral brace portion opposite the central portion, with said extension portion, said lateral brace portion, said central portion, the wing portion, and the other wing portion being coplanar.

22. The bracket of claim 21, wherein said bracket includes at least one drainage element.

23. The bracket of claim 22, wherein said bracket includes at least one mounting element.

24. The bracket of claim 21, wherein said bracket includes at least one mounting element.

25. The bracket of claim 21, wherein said extension portion has, connected thereto, a planar rear flange extending upwardly, perpendicular to said extension portion, and in parallel with the front flange, and the vertical member is configured to fit around the front, rear, and lateral flanges with the inner surfaces respectively abutting the front, rear, and lateral flanges.

26. The bracket of claim 25, wherein said bracket includes at least one drainage element.

27. The bracket of claim 26, wherein said bracket includes at least one mounting element.

28. The bracket of claim 26, wherein said bracket includes at least one mounting element.

29. The bracket of claim 17, wherein said lateral brace portion has, connected thereto, a planar rear flange extending upwardly, perpendicular to the lateral brace portion, and in parallel with the front flange, the rear side includes a respective inner surface, and the vertical member is configured to fit around the front, rear, and lateral flanges with the inner surfaces respectively abutting the front, rear, and lateral flanges.

30. The bracket of claim 29, wherein said bracket includes at least one drainage element.

31. The bracket of claim 30, wherein said bracket includes at least one mounting element.

32. The bracket of claim 29, wherein said bracket includes at least one mounting element.
